(19) United States
(12) Patent Application Publication
(10) Pub. No.: US 2016/0205198 A1
(43) Pub. Date: Jul. 14, 2016

(54) DELIVERY OF PERSONALIZED CONTENT IN SEMI-CONNECTED NETWORKS

(71) Applicant: Microsoft Technology Licensing, LLC, Redmond, WA (US)

(72) Inventors: Shrey Shah, Redmond, WA (US); Michael Novak, Redmond, WA (US)

(21) Appl. No.: 14/597,080

(22) Filed: Jan. 14, 2015

(51) Int. Cl. H04L 29/08; G06F 3/0484

(52) U.S. Cl. CPC H04L 67/141; G06F 3/0484; H04L 67/10; H04L 67/306; H04L 67/22

(57) ABSTRACT

The use of a list of presentable resources to be presented on a user interface element. The presentation computing system may, at any given time, display interface elements, such as gadgets, windows, tiles, icon and so forth. The presentation computing system also receives a presentation order associated with the resource list, and also filtering data. The presentation computing system responds to this receipt by automatically evaluating the list of resources in the presentation order. As part of the evaluation for each presentable resource in the list, the presentation computing system determines whether the corresponding presentable resource will be presented on the user interface element or at least temporarily filtered so as to not be presented on the user interface element. If the presentation computing system determines that the presentable resource will be presented, the presentation computing system causes the presentable resource to be presented on the user interface element.

### BACKGROUND

Information providers often have information and content they want to communicate to users of a particular device or system. The information providers may be the same as the entity that marketed and/or created the device or system, or the same as the entity that provided software on the entity. The information providers may want to communicate such content on their own behalf or on behalf of third parties. Such content may include, for example, news, subscription content, and other content that may inform, educate, entertain, delight, or encourage users. However, the information providers also want to increase the chance that the users will be interested in content that they provide.

Different users are likely to be interested in different content based on those users' hobbies, backgrounds, and other characteristics. The same user may be interested in different content, for example, at different times of the day, different times of the year, or when the user travels. A user's interests may change as the user ages or goes through life transitions such as graduating, getting married, or retiring.

Many electronic devices that people use, such as laptops, smart phones, and tablets, are not continuously connected to electronic networks through a Wi-Fi connection or other internet connection. Therefore, often devices can only send and receive information over the internet intermittently. It can be difficult for providers of content to personalize the content they make available to users, and particularly so when the devices on which content is used are only intermittently connected to the internet.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In accordance with at least one embodiment described herein, a computing system receives a list of presentable resources to be presented on a particular user interface element. The presentation computing system may, at any given time, display one or more user interface elements, such as gadgets, windows, tiles, icon and so forth. The presentation computing system also receives a presentation order associated with the resource list, and also filtering data.

The presentation computing system responds to this receipt by automatically evaluating the list of resources in the presentation order. As part of the evaluation for each presentable resource in the list, the presentation computing system determines whether the corresponding presentable resource will be presented on the particular user interface element or at least temporarily filtered so as to not be presented on the particular user interface element. If the presentation computing system determines that the presentable resource will be presented, the presentation computing system causes the presentable resource to be presented on the user interface element. Accordingly, there is enabled some high level of control over what is displayed on user interface elements. This allows flexible decision making, responsive to current technical challenges (such as current or anticipated future network connectivity) regarding what should be displayed to maximize targeted goals, such as user interest or value to the user.

In some embodiments, the selection of the list of presentable resources, the presentation order, and/or the filtering data may take into consideration estimated future usage of a user interface element, estimated network connectivity, and so forth.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a network with a presentation computing system and a facilitation computing system that interact in order to accomplish features described herein;

FIG. 3 illustrates a structure of an embodiment of a facilitation computing system of FIG. 2;

FIG. 4 illustrates a method by which the facilitation computing system of FIG. 3 may facilitate the presentation of presentable resources on a presentation computing system;

FIG. 5 illustrates a flowchart of a method of automatically evaluating a list of presentable resources;

FIG. 6 illustrates a flowchart of a method for the presentation computing system to notify a facilitation computing system of its inventory of presentable resources; and

FIG. 7 illustrates a flowchart of a method for conditionally using a network connection depending on the network status.

### DETAILED DESCRIPTION

In accordance with at least one embodiment described herein, a computing system receives a list of presentable resources to be presented on a particular user interface element. The presentation computing system may, at any given time, display one or more user interface elements, such as gadgets, windows, tiles, icons, and so forth. A user interface element may be the entire display screen of a computing system or any portion of it. The presentation computing system also receives a presentation order associated with the resource list, and also filtering data.

The presentation computing system responds to this receipt by automatically evaluating the list of resources in the presentation order. As part of the evaluation for each presentable resource in the list, the presentation computing system determines whether the corresponding presentable resource will be presented on the particular user interface element or at least temporarily filtered so as to not be presented on the particular user interface element. If the presentation computing system determines that the presentable resource will be presented, the presentation computing system causes the presentable resource to be presented on the user interface element. Accordingly, there is enabled some high level of control over what is displayed on user interface elements. This allows flexible decision making, responsive to current technical challenges (such as current or anticipated future network connectivity) regarding what should be displayed to maximize targeted goals, such as user interest or value to a user.

In some embodiments, the selection of the list of presentable resources, the presentation order, and/or the filtering data may take into consideration estimated future usage of a user interface element, estimated network connectivity, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

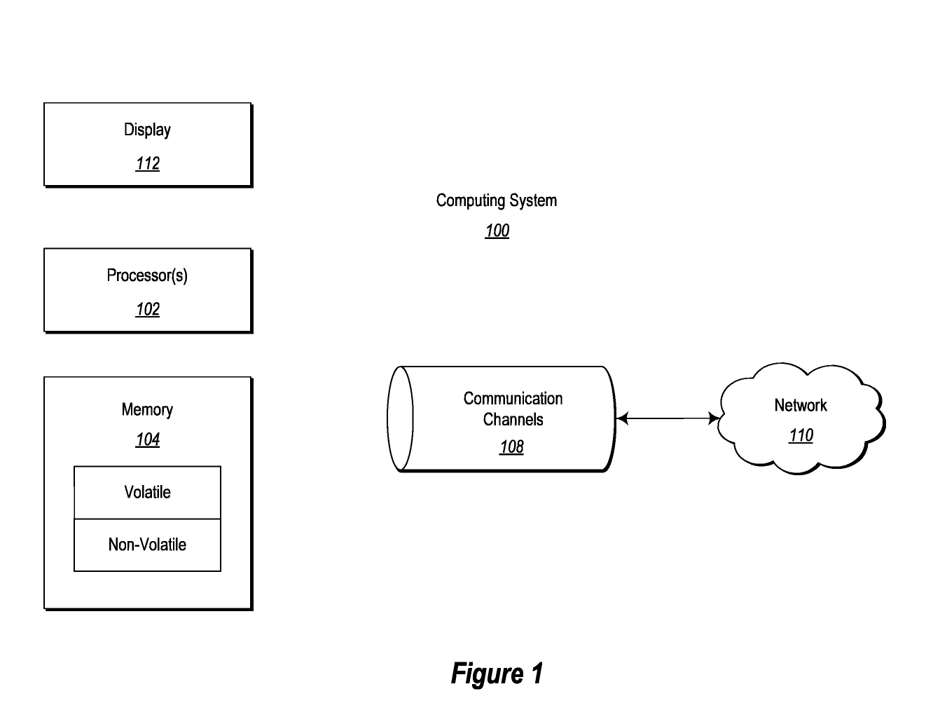

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also may include a display 112 on which user interface elements may be displayed.

Embodiments described herein may comprise or utilize a special-purpose or general-purpose computer system that includes computer hardware, such as, for example, one or more processors and system memory, as discussed in greater detail below. The system memory may be included within the overall memory 104. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

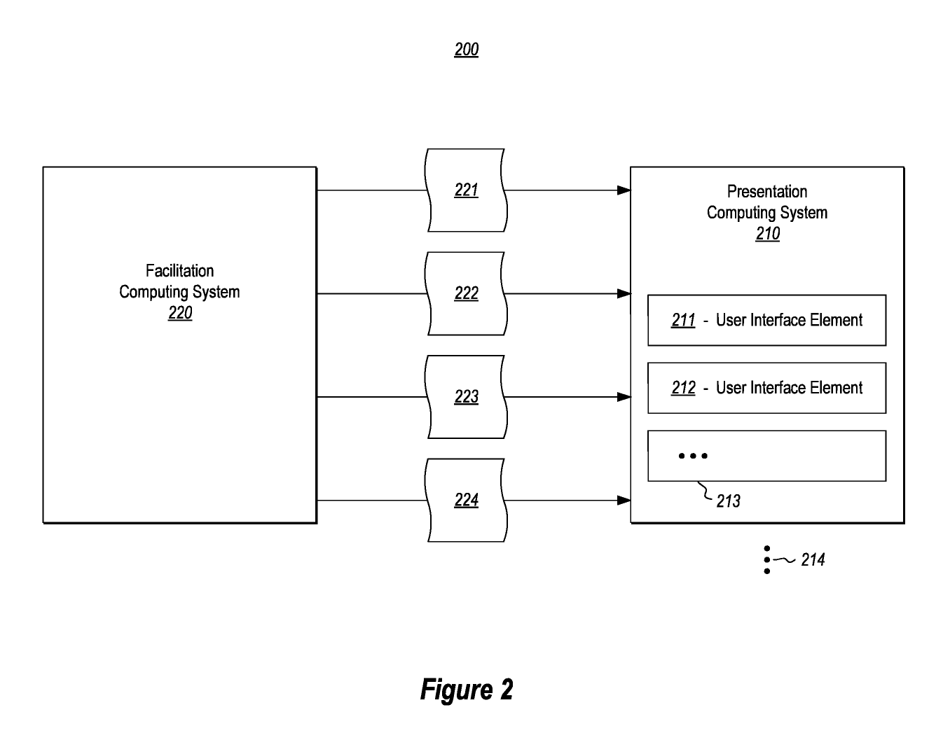

FIG. 2 illustrates a network environment 200 that includes a presentation computing system 210 and a facilitation computing system 220, each of which perhaps being structured as described above for the computing system 100 of FIG. 1. The presentation computing system 210 presents one or more user interface elements. For instance, if the presentation computing system 210 were the computing system 100 of FIG. 1, the presentation computing system 210 might display user interface elements upon the display 112.

The computing system 210 is illustrated as including two user interface elements 211 and 212. However, the ellipsis 213 represents that the principles described herein are not limited to any particular number of user interface elements that are presented by the presentation computing system. For instance, the presentation computing system 210 may present but a single user interface element, or may present any number of user interface elements. Furthermore, the number of user interface elements that are displayed by the presentation computing system 210 may vary over time, depending on state. Also, as previously mentioned, the principles described herein are not limited to any particular type of user interface element.

In one embodiment, the presentation computing system 210 has one or more processors that execute computer-executable instructions in response to having received items over a network. Specifically, the presentation computing system 210 responds to receiving one or more of the following items: presentable resources 221, a list of presentable resources 222, a presentation order 223, and filtering data 224. The presentable resources 221 are each potentially to be presented on a particular user interface element 211 or on multiple user interface elements (e.g., 211, 212, and so forth 213). The list 222 of presentable resources includes a list of identifiers for the presentable resources 221. The presentation order 223 is associated with the list of presentable resources 222 (or the presentable resources 221 on the list 222), and describes an order in which the presentable resources 221 are to be evaluated. The filtering data 224 is associated with at least one particular presentable resource 221 in the list of presentable resources 222.

Presentable resources 221 may include photographs, artwork, pictures, animation, videos, hyperlinks, or other resources. For example, one presentable resource 221 might be a hyperlink for an application that can be downloaded to a presentation computing system 210. Alternatively or in addition, the selection of the hyperlink may cause a browser to navigate to a website from which the application can be downloaded or from which more information about the application may be obtained.

Some presentable resources 221 may be intended solely for user enjoyment. For instance, a collection of photographs that the user (or a group that the user belongs to) that may have taken or stored that may be included within the presentable resources 221. There may be a different photograph displayed within a user interface depending on context (e.g., whether the user is proximate one of the individuals tagged in the photograph). Accordingly, whether the presentable resources present a message, or whether simply for user enjoyment, the principles described herein enable intelligent decision making regarding what to present to the user, and in what time.

Preferably, the systems and methods described in this application allow for presentable resources 221 to be presented in such a way that a user of a presentation computing system 210 is presented with resources 221 that are of interest to that user and/or are most appropriate given the context. The presentable resources 221 may be considered personalized to a user when, considering factors such as a user's characteristics, habits, or previous purchases, a user is likely to be interested in that presentable resource 221.

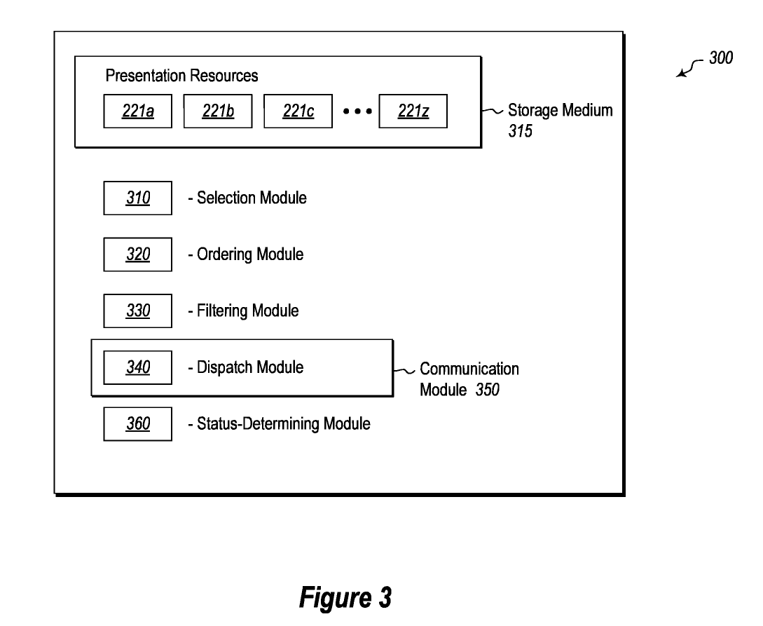

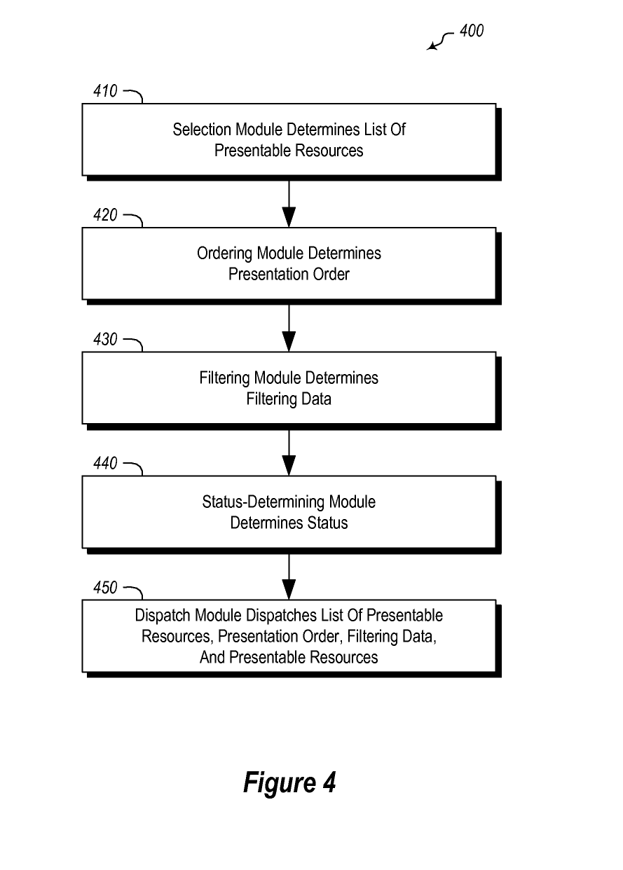

FIG. 3 illustrates an example facilitation computing system 300, which represents an example of the facilitation computing system 220 of FIG. 2. FIG. 4 illustrates a method 400 by which the facilitation computing system 300 may facilitate the presentation of presentable resources 221 on a presentation computing system 210. As the method 400 of FIG. 4 may be performed by the facilitation computing system 300 of FIG. 3, FIG. 3 and FIG. 4 will now be described together.

A selection module 310 of the facilitation computing system 300 may determine (or formulate) the list of presentable resources 222 (act 410). In so doing, the selection module 310 facilitates the presentation of presentable resources 221 on one or more particular user interface elements 211, 212, and so forth. That facilitation computing system 300 may have a computer-readable storage medium 315 that has a set of presentable resources 221 (221a, 221b, 221c, etc.) stored thereon.

In some embodiments, the presentable resource 221 may have a determined useful lifespan. A useful lifespan may be automatically determined by the facilitation computing system 220 based on characteristics of the presentable resource 221, at the time a presentable resource 221 is put onto the facilitation computing system 220, or through a variety of other ways.

For instance, the determined useful lifespan of a presentable resource may include two aspects. First, one aspect of the determined useful lifespan of a presentable resource is the entire length of time for which a resource may be shown. Some presentable resources 221 may be presented only to a user one time, whereas other presentable resources 221 may be configured to be presented to users repeatedly. Some presentable resources 221 may be presented on a user interface element 211 for a long time (which may be days or hours, for example), while others may only be presented for shorter periods. These factors contribute to the length of time a resource may be shown.

The second aspect of the determined useful lifespan of a presentable resource 221 is the date (if any) beyond which a presentable resource 221 may no longer be presented to a user interface element 211. This relates to the “staleness” of the presentable resource 221. For example, if the presentable resource is associated with or showing an upcoming event, once the event occurs, the presentable resource showing the upcoming event might be considered outdated (or “stale”). On the other hand, some presentable resources are less subject to becoming stale. Such data might also be referred to as “evergreen”, in that the passage of time does not tend to render the data less useful. For instance, a nature picture might have the same appeal to an individual yesterday as it will next year.

The selection module 310 may be configured to select a subset of the entire set of presentable resources 221 by correlating characteristics of presentable resources 221 with previously received user engagement data, and/or by correlating the determined useful lifespans of presentable resources 221 with data regarding the historical network connectivity of the presentation computing system 210. For example, if there are three presentable resources 221a, 221b, and 221c on the facilitation computer system 300, the selection module 310 may select, for example, 221b and 221c to be on the list of presentable resources 222 based on the criteria described above (e.g., user engagement data, useful lifespans, historical network connectivity, and so forth).

The selection module 310 may also be configured to select a subset of the set of presentable resources 221 by correlating a useful lifespan of presentable resources 221 with estimated future network connectivity of the presentation computing system 210. This estimated future network connectivity may be based on data regarding historical network connectivity of the presentation computing system 210 or a user's asserted future plans. Asserted future plans may be determined based on, for example, a user's calendar or schedule, airline tickets purchased, or similar other indicators of a person's future plans. The selection module 310 may determine the list of presentable resources 222 to be presented so that an average of the useful lifespan of presentable resources 221 presented to the particular user interface element 211 increases when a length of time for which the presentation computing system 210 is expected to be disconnected from internet access increases. This may be accomplished by, for instance, by increasing the average of the useful lifespan of items included within the list of presentable resources 222 presented to the presentation computing system 210. The selection module 310 may determine a different subset of the set of presentable resources 221 to present to the user interface element when there is a change in the network connectivity of the presentation computing system 210.

The presentation order 223 of the presentable resources 221 in the list of presentable resources 222 may be determined by an ordering module 320 in the facilitation computing system 300 (act 420 in FIG. 4). The presentation order 223 defines the order in which the presentable resources are evaluated for potential display.

Further, the filtering data 224 may be identified by a filtering module 330 in the facilitation computing system 300 (act 430 in FIG. 4). The filtering data 224 includes information by which the presentation computing system 210 may determine whether or not to display the corresponding presentable resource. As an example, the filtering data 224 may include a determined useful lifespan of one or more presentable resources 221.

The filtering data 224 may time-limit presentable resources 221 so that they are temporarily filtered until a certain date or time or are never presented after a certain date. For example, filtering data 224 may include instructions that tell a presentation computing system 210 to display certain presentable resources 221 at certain times of the day. Presentable resources 221 such as advertisements for coffee or breakfast foods may be displayed to a user early in the morning. Different presentable resources 221 may be presented to users based on whether they are located in metropolitan or rural areas, and so forth. Articles with useful information related to visiting national parks or other sites of interest may be presented to users when they are located near those areas. Filtering data 224 for a presentable resource 221 that includes a holiday greeting may instruct that the presentable resource 221 is not to be presented after that holiday occurs. Filtering data 224 for notices or offerings for computer applications may instruct that the notice is not to be presented if the presentation computing system 210 already has that computer application downloaded to the system 210.

Filtering data 224 may instruct that certain presentable resources 221 are only to be presented to a user interface element 211 when the presentation computing system 210 is—or is not—connected to the internet on an unmetered network. Other filtering data 224 may instruct that a presentable resource 221 is only to be presented to a user interface element 211 once, or that a presentable resource 221 may be presented to a user interface element 211 multiple or an unlimited number of times. For resources 221 permitted to be presented to a user interface element 211 multiple or an unlimited number of times, the filtering data 224 may limit the frequency with which the resource 221 may be presented.

The selection module 310 or ordering module 320 may also be configured to associate the presentation order 223 with the list of presentable resources 222. The presentation order 223 may establish a first presentable resource 221a, a second presentable resource 221b, and so forth, until the last presentable resource 221z. The presentation computing system 210 evaluates the presentable resources 221 in the presentation order 223. The presentation order 223 may be cyclical, repetitive, or include branches or various decision trees.

The presentable resources 221 on the list of presentable resources 222, the list of presentable resources 222 itself, the presentation order 223, and the filtering data 224 may be provided to the presentation computing system 210 by a dispatch module 340 of the facilitation computing system 300 (act 450). Although FIG. 2 shows the facilitation computing system 220 as only interfacing with a single presentation computing system 210, the principles described herein are not limited to that whatsoever. For instance, the facilitation computing system 210 might perform the method 400 for any number of presentation computing systems by, for instance, providing presentable resources, lists thereof, presentation orders, and filtering data appropriate for each of those presentation computing systems. For instance, the dispatch module may also provide another list of presentable resources 222, the presentable resources 221 on that list 222, a presentation order 223, and filtering data 224 to one or more additional presentation computing systems (as represented by the ellipsis 214).

The dispatch module 340 may be part of a communication module 350 configured to also receive data regarding any user engagement with a user interface element 211 and configured to receive data regarding the historical network connectivity of the facilitation computing system 300 with the presentation computing system 210. The communication module 350 may also send filtering data 224 to the presentation computing system 210, either separately from the presentable resources 221 and a presentation order 223 or with them. The communication module 350 may be configured to send presentable resources 221 and a presentation order 223 to a second presentation computing system 210, to receive data regarding any user engagement with the presentable resources 221 from the second presentation computing system 210, and configured to receive data regarding the historical network connectivity of the second presentation computing system 210.

The facilitation computing system 300 may also have a status determining module 360 configured to estimate a status (act 440) of a network connection between the dispatch module 340 and the presentation computing system 210 and to determine whether or not to activate the dispatch module 340 based on the estimated status. Activating the dispatch module 340 results in one or more of the presentation order 223, the identified filtering data 224, the list of presentable resources 222, or at least one of the presentable resources 221 being provided to the presentation computing system 210.

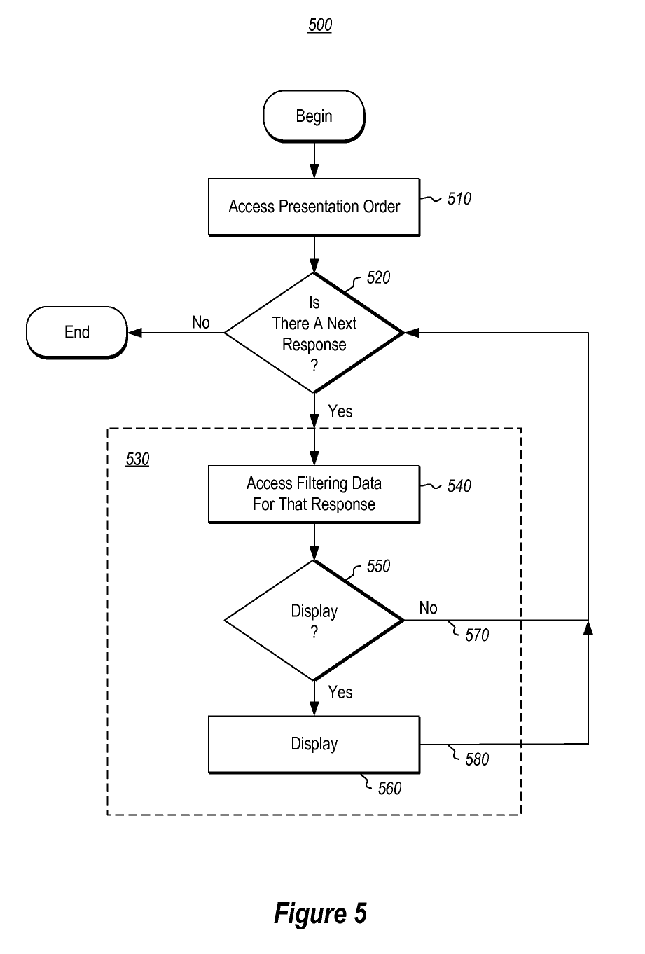

FIG. 5 illustrates a flowchart of a method 500 of automatically evaluating a list of presentable resources 222. The method 500 may be performed by, for instance, the presentation computing system 210 of FIG. 2.

The presentation computing system 210 responds to receiving items from the facilitation computing system 220 by automatically evaluating the list of presentable resources 222 in the presentation order 223. The presentation computing system 210 automatically evaluates the list 222 by, for each of at least some of the presentable resources 221 in the list 222, determining whether a resource 221 will be presented or filtered. Furthermore, if the presentation computing system 210 confirms that a resource 221 will be presented, the presentation computing system 210 further causes the resource to be presented. The presentation computing system 210 may begin to automatically evaluate the list of presentable resources 222 in the presentation order 223 from the beginning of the list 222 again when a network connection status of presentation computing system 210 changes, or when the presentation computing system 210 has evaluated the entire list of presentable resources 222. If the presentation computing system 210 receives another list of presentable resources 222, the presentation computing system 210 performs an act of stopping evaluating the first list of presentable resources 222; and an act of starting evaluating the second list of presentable resources 222 in a corresponding presentation order.

Method 500 shows how a presentation computing system 210 determines if presentable resources on the list of presentable resources 222 will be presented. The method begins with the presentation computing system 210 accessing the presentation order 223 (act 510). Then the presentation computing system 210 determines if there is a “next resource” (act 520) in accordance with the presentation order 223. In some cases, the presentation order 223 may indicate that a first resource 221a of the presentable resources 221 is to be evaluated first. Once processing completes with respect to that presentable resource (e.g., by performing the evaluation of act 530 described below), the evaluation will move forward to the next resource that is dictated by the presentation order 223. Once there are no further resources to be evaluated in the list (“No” in decision block 520), the method 500 may end for now. As an example, if the presentation order 223 indicates that the order is simply to move from resource 221a through 221z alphabetically, then once the evaluation 530 has occurred 26 times and has completed for resource 221z, the method 500 would then end.

If there is a next resource according to the presentation order 223, the presentation computing system 210 evaluates the next resource (act 530). The act of evaluating a resource includes, for each of at least some of the presentable resources 221 in the list 222, accesses filtering data 224 for that presentable resource 221 (act 540). Thereafter, the presentation computing system 210 determines whether the resource 221 will be presented or filtered (act 550) based on that filtering data. Although the filtering data 540 is illustrated as being accessed for a given presentable resource immediate prior to the decision of whether to display that resource, the filtering data for all or some of the presentable resource 222 may alternatively be gather beforehand.

The filtering data 224 may represent that the determination of whether a presentable resource 221 will be presented or at least temporarily filtered may be at least in part based on whether the presentation computing system 210 is currently connected to the internet. The filter data 224 might also represent that the determination may also be based on a user's prior engagement or lack of engagement with the particular user interface element, or based on a user's prior activities in general.

For instance, a user's “prior engagement” with a user interface element might include a history of the presentable resource being displayed on that user interface element, and perhaps if so, how the user interacted with the user interface element (or the presentable computing system in general) at that time. When a presentable resource 221 allows a user to interact with the presentable resource 221 (such as by viewing a video, selecting a hyperlink, or so forth), a user of the particular user interface element 211's “prior engagement” with that presentable resource 221 includes data indicating that a user has interacted with the presentable resource 221. When a presentable resource 221 only permits passive viewing by a user, the “prior engagement” data might include data indicating that the presentable resource 221 was presented to a user interface element 211 while a user interacted with the presentation computing system 210. By receiving data from the presentation computer system 210 regarding a user's “prior of engagement” with the user interface element and/or the presentable resource, the selection module 410 and ordering module 420 of the facilitation computing system 220 may be better able to select and order presentable resources 221 for that user.

When a presentable resource allows a user to interact with the presentable resource, such as by viewing a video, selecting a hyperlink, or so forth, the lack of engagement data might include data indicating that a user has interacted with a presentation computing system 210 when a presentable resource 221 was presented on the presentation computing system 210 but did not interact with the presentable resource 221. When a presentable resource 221 only permits passive viewing by a user, the lack of engagement date might include data indicating that the presentable resource 221 was always filtered and never presented to the user. By receiving data from the presentation computer system 210 regarding a user's lack of engagement with previously-received presentable resources 221, the selection module 410 and ordering module 420 of the facilitation computing system 220 may be better able to select and order presentable resources 221 for that user.

A user of the particular user interface element 211's “activities” on the particular presentation computing system 210 or on other presentation computing systems 210 are data regarding the things that a user uses the computing system 210 for, such as web browsing, document preparation, e-reading, playing games, and so forth. By receiving data from the presentation computer system 210 regarding a user's activities, the selection module 410 and ordering module 420 of the facilitation computing system 220 may be better able to select and order presentable resources 221 for that user.

The act of determining whether a presentable resource 221 will be presented or at least temporarily filtered may be at least in part based on data regarding at least one of the following factors: the time of day where the presentation computing system 210 or user interface element 211 is being used, the geographic location of the presentation computing system 210, whether a presentable resource 221 has been previously presented to a user of presentation computing system 210 and if so, how recently the presentable resource 221 was presented,

If it is determined that the presentable resource 221 will be presented (“Yes” in decision block 550), the presentation computing system 210 performs an act of causing the presentable resource 221 to be presented on a particular user interface element 211 (act 560). If the presentation computing system 210 determines that the first presentable resource 221 will not be presented (“No” in decision block 550), the system 210 then determines if there is a “next resource” (arrow 570).

If any presentable resource 221 is presented (act 560), such as the first presentable resource 221 a, the metadata associated with that presentable resource 221 or the filtering data 224 may establish a length of time for which that presentable resource 221 is to be presented. This length of time may be any amount of time less than (or perhaps equal to) the determined useful lifespan of the resource 221. When the length of time for which a presentable resource 221 is to be presented has passed, the presentation computing system 210 then reverts to act 520 (see arrow 580). It is then determined whether there is a next presentable resource (decision block 520) in accordance with the presentation order 223.

This process may continue until the system 210 evaluates the last presentable resource 221z on the list 222. Alternatively or in addition, if a network connection status of the presentation computing system 210 changes, at that point the method 500 may begin again with the first presentable resource 221a on the list 222.

If at any time during the process of evaluating a list 222 of presentable resources 221, the network connection status of the presentation computing system 210 changes, the computing system 210 may begin to automatically evaluate the list 222 of presentable resources 221 in the presentation order 223 from the beginning of the list 222 again.

The presentation computing system 210 may perform method 500 separately (and perhaps concurrently) for each user interface element (211, 212, and so forth) in the presentation computing system 210's display. The filtering data 224 may include instructions that may alter the acts of method 500 for various user interface elements (211, 212, and so forth). The filtering data 224 may differ for different user interface elements.

Depending on the filtering data 224 and other factors, the presentation computing system 210 may present at least some of the presentable resources 221 to one or more particular user interface elements (211, 212, and so forth). Once a presentable resource 221 is presented to a user interface element 211, metadata associated with the presentable resource 221 or filtering data 224 may determine how long the presentable resource 221 will be presented. The length of time a presentable resource 221 will be presented may vary depending on what the specific presentable resource 221 is, what type of presentable resource 221 it is, or the particular user interface element 211 it is presented upon.

Causing a presentable resource 221 to be presented may cause one or more “themes” to be presented on the user interface elements 211 of a presentation computing system 221. Such themes may include, for example, presenting similar presentable resources 221 on multiple or all of the user interface elements 211 of a computing system 210. Similarities may be based on coloration or other visual aspects of the presentable resources 221, to create a unique visual appeal for the theme. Other similarities may include content-based themes. For example, one theme may be health-focused, with a variety of presentable resources 221 all presented that encourage or help a user to be healthy. Other similarities may be location-based. If a GPS in a presentation computing system 210 is enabled and the system 210 is consistently used in a certain geographic region, such as a city or state, when the GPS is suddenly used in a new geographic region (thus indicating a person has likely recently traveled), a theme may encompass several presentable resources 222 all associated with the new geographic region.

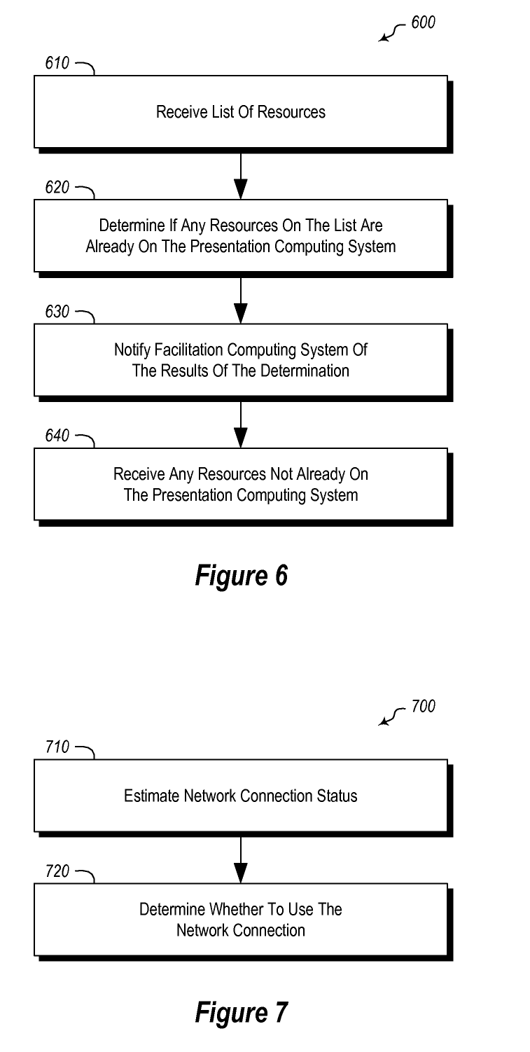

Prior to receiving a list of presentable resources 222, the presentation computing system 210 may prepare a list of all or a subset of the presentable resources 221 that are already saved to the presentation computing system 210 and send the list to a facilitation computing system 220. Or the facilitation computing system 220 may maintain records of which presentable resources 221 have been previously dispatched to a particular presentation computing system 210. Or, as shown in FIG. 6, the presentation computing system 210 may perform a method 600 that includes performing an act of determining whether a presentable resource 221 is stored on the presentation computing system 210 (act 620) after the act of receiving a list of presentable resources 222 (act 610), and performing an act of notifying a facilitation computing system 220 of the result of that act of determining (act 630). If the presentation computing system 210 does not already have stored on it a particular presentable resource 221 that is included in a particular received list of presentable resources 222 prior to receiving that list 222, the presentation computing system 210 may receive the particular presentable resource 221 over the network and place it into temporary or permanent storage on the presentation computing system 210 when network connectivity permits the resource 221 to be received (act 640).

When the presentation computing system 210 prepare a list of all or a subset of the presentable resources 221 that are already saved to the presentation computing system 210 and send the list to a facilitation computing system 220, the list may preferably include only those presentable resources 221 which are not expired. That is, for resources 221 with filtering data 224 that states that they are never to be presented after a certain date, the presentable resources may be considered expired after that date.

For situations in which the presentation computing system 210 is only intermittently connected to the internet, the selection module 410 of the facilitation computing system 220 may have a preference to select presentable resources 221 that have a longer useful lifespan. Similarly, the events on a user's calendar, purchases of airline tickets, use of an airline Wi-Fi network, or other variables may suggest that it is possible a user may be likely to be disconnected from the internet for a period of time. In that case, the presentation computing system might anticipate that there could be considerable time upcoming when the user will be disconnected form the internet. If that were the case, the selection module 410 of the facilitation computing system 220 may be configured to select presentable resources 221 that have a longer useful lifespan or to select presentable resources so that an average of the useful lifespan of the presentable resources 221 presented to the particular user interface element 211 or computing system 210 or included on the list of presentable resources 222 may tend to be longer. Similarly, when a computing system 210 is expected to be continuously or regularly connected to the internet, the average useful lifespan of the presentable resources 221 presented may tend to be shorter.

As shown in FIG. 7, the presentation computing system 210 may also perform method 700 that includes an act of estimating a status of a network connection between the presentation computing system 210 and a facilitation computing system 220 (act 710); and an act of determining whether or not to use the network connection to connect to the facilitation computing system 220 based on the estimated status (act 720). These acts, shown in FIG. 7, may be performed prior to steps 610 (receiving a list of resources 221), 630 (notifying the facilitation computing system 220 of the results of that determination), or 640 (receiving any presentable resources 221 not already on the presentation computing system 210). They may also or instead be performed before the presentation computing system 210 receives ordering data 223, facilitation data 224, or receiving other presentable resources 221.

The presentation computing system 210 may send a message to the facilitation computing system 220 when a new list of presentable resources 222 is needed. Such need may be determined based on filtering data 224 or other metadata associated with the presentable resources 221 by the facilitation computing system 220. For example, the occurrence of an event such as the evaluation of the last presentable resource 221z on a list of presentable resources 224 may trigger the sending of this message. Other events that may cause the facilitation computing system 220 to trigger the sending of such a message by the presentation computing system 210 include the circumstance in which all the presentable resources 221 on a list of presentable resources 222 have been presented to the user interface elements 211. The message sent to a facilitation computing system 220 may include data on the user's engagement with certain user interface elements 211, computer applications, or presentable resources 221, and so forth.

Data, messages, and things transferred between the presentation computing system 210 and the facilitation computing system 220, including presentable resources 221, a list of presentable resources 222, the presentation order 223, and filtering data 224 may be transferred when a Wi-Fi or other unmetered network connection is available. How frequently a new list of presentable resources 222 is presented to a presentation computing system 210 may depend at least in part on how frequently an unmetered connection exists. The type of presentable resources 221 and specific personable resources 221 included on the list of presentable resources 222 may vary depending on how frequently or continuously a presentation computing system 210 has internet access or an unmetered internet connection. A system may prioritize the downloading of new lists 222, ordering data 223, and filtering data 224 so that these are received first before new presentable resources 221. A user may preferably be able to control the systems and methods so that content is only updated when an unmetered connection exists, if that is the user's preferences. The order in which presentable resources 221 are downloaded to a presentation computing system 210 may be based on the presentation order 223.

Accordingly, the principles described herein provide a mechanism to allow for intelligent decision making regarding whether to display presentable resources on various user interface elements of a user system or device. Furthermore, the presentation may be flexible and responsive to context, prior usage of the presentable resource or its user interface element, and/or anticipated connectivity to the Internet. This thereby increases the likelihood of presenting more highly valued content to the user, and allows more effective and efficient use of the user system or device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, the execution causes the presentation computing system to respond to receiving over a network a list of presentable resources to be presented on a particular user interface element, receiving over the network a presentation order associated with the list of presentable resources, and receiving over the network filtering data associated with at least one particular presentable resource in the list of presentable resources, by performing the following:
automatically evaluating the list of presentable resources in the presentation order, the act of automatically evaluating comprising performing the following acts for each of at least some of the presentable resources in the list of presentable resources:
determining whether a presentable resource will be presented on the particular user interface element or at least temporarily filtered so as to not be presented on the particular user interface element; and
if it is determined that the presentable resource will be presented, an act of causing the presentable resource to be presented on the particular user interface element.

2. The computer program product of claim 1, the computer-executable instructions being further structured such that, when interpreted by the one or more processors, the interpretation causes the presentation computing system to further perform the following:
an act of determining whether a presentable resource is stored on the presentation computing system; and
an act of notifying a facilitation computing system of the result of the act of determining whether a presentable resource is stored on the presentation computing system.

3. The computer program product of claim 1, where the execution of the computer-executable instructions on the computer-readable storage media further causes the presentation computing system to perform the following:
an act of estimating a status of a network connection between the presentation computing system and a facilitation computing system; and
an act of determining whether or not to use the network connection to connect to the facilitation computing system based on the estimated status.

4. The computer program product of claim 1, wherein the act of determining whether a presentable resource will be presented or at least temporarily filtered is at least in part based on whether the presentation computing system is currently connected to the internet.

5. The computer program product of claim 1, wherein the act of determining whether a presentable resource will be presented on the particular user interface element is based on data stored on the presentation computing system regarding a user of the particular user interface element's “prior engagement” or “lack of engagement” with other presentable resources.

6. The computer program product of claim 1, wherein the act of determining whether a presentable resource will be presented on the particular user interface element is based on data stored on the presentation computing system regarding a user of the particular user interface element's “activities” on the particular presentation computing system or on other presentation computing systems.

7. The computer program product of claim 1, wherein, prior to the presentation computing system receiving a list of presentable resources, the presentation computing system prepares a list of all or a subset of the presentable resources that are already saved to the presentation computing system and sends the list to a facilitation computing system.

8. The computer program product of claim 1, wherein the presentation computing system begins automatically evaluating a list of presentable resources in the presentation order from the beginning of the list again when a network connection status of the presentation computing system changes.

9. The computer program product of claim 1, wherein the presentation computing system begins automatically evaluating a list of presentable resources in the presentation order from the beginning of the list again when the presentation computing system has evaluated the entire list of presentable resources.

10. The computer program product of claim 1, the received list of presentable resources being a first list of presentable resources, wherein the computer-executable instructions are further structured such that the presentation computing system is also configured to respond to receipt of a second list of presentable resources by performing the following:
an act of stopping evaluating the first list of presentable resources; and
an act of starting evaluating the second list of presentable resource in a corresponding presentation order.

11. The computer program product of claim 1, wherein causing a presentable resource to be presented on the user interface element causes one or more “themes” to be presented on the user interface elements of a presentation computing system.

12. A system for facilitating the presentation of presentable resources on a particular user interface element, the system comprising:
a selection module configured to determine a list of presentable resources to be presented in a particular user interface element;
an ordering module configured to determine a presentation order associated with presentable resources on the list of presentable resources;
a filtering module configured to identify filtering data associated with a particular resource in the list of presentable resources; and
a dispatch module configured to provide the presentable resources on the list of presentable resources, the presentation order, and the identified filtering data to a computing system that presents at least some of presentable resources to the particular user interface element, the filtering data structured to be interpretable by the presentation computing system such that the presentation computing system evaluates the presentable resources in the presentation order, and either confirms presentation of a particular presentable resource on the particular user interface element or at least temporarily filters a particular presentable resource so as to not be presented on the particular user interface element.

13. The system of claim 12, where the system further comprises a status-determining module configured to estimate a status of a network connection between the dispatch module and the presentation computing system that presents at least some of presentable resources to the particular user interface element; and to determine whether or not to activate the dispatch module based on the estimated status.

14. The system of claim 12, the particular user interface element being a first user interface element, the presentation order being a first presentation order, the list of presentable resources being a first list of presentable resources, the filtering data being first filtering data;
where the system also facilitates the presentation of presentable resources on a second user interface element;
where the selection module is also configured to determine a second list of presentable resources to be presented in the second user interface element;
where the ordering module is also configured to determine a second presentation order for the second list of presentable resources;
where the filtering module is also configured to identify second filtering data associated with each presentable resource in the second list of presentable resources; and
where the dispatch module is also configured to provide the presentable resources on the second list of presentable resources, the second presentation order, and the identified second filtering data associated with each presentable resource in the second list of presentable resources to the presentation computing system on the second user interface element.

15. The system of claim 12, where the selection module determines the list of presentable resources to be presented in the particular user interface element by correlating characteristics of presentable resources with user engagement data.

16. The system of claim 12, where the selection module determines the list of presentable resources to be presented in the particular user interface element by correlating a useful lifespan of presentable resources with estimated future network connectivity of the presentation computing system, which estimated future network connectivity is based on data regarding historical network connectivity of the presentation computing system.

17. The system of claim 12, where the selection module determines the list of presentable resources to be presented in the particular user interface element by correlating a useful lifespan of presentable resources with estimated future network connectivity of the presentation computing system, which estimated future network connectivity is based on a user's asserted future plans.

18. The system of claim 12, where the selection module determines the list of presentable resources to be presented in the particular user interface element so that an average of a useful lifespan of presentable resources presented to the particular user interface element or included on the list of presentable resources sent to the presentation computing system increases when a length of time for which the presentation computing system is expected to be disconnected from internet access increases.

19. A system comprising:
a computer-readable storage medium that has a set of presentable resources stored thereon, where each presentable resource is configured to have a determined useful lifespan;
a communication module configured to send presentable resources and a presentation order to a computing system having displayed thereon a user interface element and configured to receive data regarding any user engagement with the user interface element and configured to receive data regarding the historical network connectivity of the system with the presentation computing system; and
a selection module configured to select a subset of the set of presentable resources to be provided to the presentation computing system for potential presentation on the user interface element by correlating characteristics of presentable resources with the previously received user engagement data, and by correlating the determined useful lifespans of presentable resources with the data regarding the historical network connectivity.

20. The system of claim 19, where the selection module determines the list of presentable resources to be presented in the particular user interface element so that an average of the useful lifespan of presentable resources sent to a computing system increases when a length of time for which the presentation computing system is expected to be disconnected from internet access increases.
